(19) United States
(12) Patent Application Publication
(10) Pub. No.: US 2020/0016541 A1
(43) Pub. Date: Jan. 16, 2020

(54) MEMBRANE TUBE

(71) Applicant: PLANSEE SE, REUTTE (AT)

(72) Inventors: MARKUS HAYDN, REUTTE (AT); MATTHIAS RUETTINGER, REUTTE (AT); MARKUS KOEGL, REUTTE (AT)

(21) Appl. No.: 16/468,055

(22) PCT Filed: Nov. 9, 2017
(86) PCT No.: PCT/AT2017/000075

§ 371 Date: Jun. 10, 2019

(30) Foreign Application Priority Data
Dec. 9, 2016 (AT) GM 302/2016

(51) Int. Cl. B01D 63/06; B01D 69/04; B01D 71/02

(52) U.S. Cl. CPC B01D 63/065; B01D 69/04; B01D 2313/23; B01D 2313/025; B01D 2313/143; B01D 71/022

(57) ABSTRACT

A membrane tube is provided for the permeative separation of a gas from gas mixtures. The membrane tube has at least two membrane tube sections, each with a porous, gas-permeable, metallic, tubular support substrate, and a membrane which is selectively permeable for the gas to be separated off. The tube also has, applied to the support substrate around the circumference, at least one connecting section which is gastight at least on the surface and by way of which the two adjacent membrane tube sections are joined, and at least one spacer in the region of the connecting section. The spacer projects in the radial direction to above the membrane.

The present invention relates to a membrane tube element as claimed in claim 1, a membrane tube as claimed in claim 2 and a membrane tube system as claimed in claim 13 for the permeative separation of a gas from gas mixtures.

Membrane tube systems of this type are generally used for the selective separation of a gas from gas mixtures, in particular for separating hydrogen (H₂) from hydrogen-containing gas mixtures (e.g. steam-reformed natural gas). As is known, the property of being selectively permeable for particular atoms or molecules (e.g. H₂) as is displayed by particular materials is exploited by using them as thin coating (“membrane”), e.g. as layer, on a support or as free-standing sheet for separating a gas space for the gas mixture from a gas space for the gas to be separated off. For example, if a gas mixture having a particular partial pressure of the gas to be separated off, e.g. having a particular H₂ partial pressure, is brought to one side of the membrane, the atoms/molecules of the gas to be separated off seek to get through the membrane to the other side until the same partial pressure of the gas to be separated off prevails on both sides. Important parameters which determine the performance of a separation system are, inter alia, operating temperature and membrane layer thickness. It is generally true that, at least in the case of metallic membranes, the higher the operating temperature and the thinner the membrane, the greater is the specific gas flow of the gas to be separated off (e.g. H₂). Plants for separating off hydrogen are typically operated at an operating temperature of 450-900° C. The layer thickness of the membrane for separating off hydrogen is typically in the region of a number of microns (μm) and the membrane therefore has a very low dimensional stability and stiffness, for which reason it is frequently configured as layer on a porous, gas-permeable, tubular support substrate which ensures gas supply to and/or gas transport away from the membrane and provides a surface for application of the membrane. Preference is given to using metallic materials for the tubular support substrate since, in comparison with ceramic materials, they have lower production costs and can be relatively easily joined to a metallic connecting part which is gastight at least on the surface, e.g. by welding or soldering. Via this connecting part, the membrane tube can be integrated into a module (having a plurality of membrane tubes of this type, also referred to as membrane tube system) or more generally into a plant within which the gas separation is carried out. A plurality of these membrane tubes are typically arranged in a bundle.

Apart from the operating temperature and the membrane layer thickness, the membrane area has a critical influence on the performance of such a plant. In order to maximize the membrane area in a plant, the membrane tubes are generally made with a diameter which is small compared to their length (for example, the length of a membrane tube can be in the order of meters while the diameter is in the order of centimeters) and assembled to form a bundle in which the individual parallel elements have a very small distance from one another. In practice, various challenges occur here: due to the comparatively great length and low intrinsic stability, vibrations or deformations can occur during transport, during start-up (owing to temperature-induced expansion of material on heating) or in use (owing to irregular gas flows) and lead to contact between the membrane tubes. These mechanical contacts between adjacent membrane elements can cause damage to the membrane arranged on the outside of the membrane elements, which puts their gastightness at risk. However, for reliable function, it is absolutely necessary that gastight separation of the two gas spaces, at least insofar as the further gases present in addition to the gas to be separated off in the gas mixture are concerned, is ensured over the entire time of operation of the plant. The system also has to withstand very high temperatures in the range up to 900° C. and also high pressure differences of more than 10 bar, particularly for the isolation of H₂.

It is an object of the present invention to provide a membrane tube element, membrane tube and a membrane tube system of the type indicated above, in which the membrane tubes can be arranged in a bundle and reliable gastightness of the two gas spaces is ensured during operation over long periods of use and at high operating temperatures.

The object is achieved by a membrane tube element as claimed in claim 1 and also by a membrane tube as claimed in claim 2 and a membrane tube system as claimed in claim 13. Advantageous embodiments of the invention are indicated in the dependent claims.

According to the present invention, a membrane tube element for the permeative separation of a gas from gas mixtures (e.g. H₂ from H₂-containing gas mixtures) is provided. The membrane tube element has at least one membrane tube section and at least two connecting parts which are gastight at least on the surface, where the membrane tube section is joined at each end face to a connecting part. The membrane tube section has a porous, gas-permeable, metallic, tubular support substrate to which a membrane which is selectively permeable to the gas to be separated off has been applied around the outside. According to the invention, at least one spacer is arranged in the region of at least one connecting part so as to project in the radial direction to above the membrane. Here, projecting radially means that the spacer has a greater maximum distance from the midpoint of the tubular membrane tube element than the membrane, or expressed in other words that the maximum external diameter of the spacer is greater than the maximum external diameter of the membrane tube section with the membrane.

Furthermore, a membrane tube for the permeative separation of a gas from gas mixtures is proposed according to the present invention. The membrane tube has at least two membrane tube sections which each have a porous, gas-permeable, metallic, tubular support substrate on which a membrane which is selectively permeable to the gas to be separated off has been applied around the outside. At least one connecting section which is gastight at least on the surface is provided between two adjacent membrane tube sections so as to join the two adjacent membrane tube sections. According to the invention, the membrane tube has at least one spacer which projects in the radial direction to above the membrane in the region of the connecting section. In preferred embodiments, one spacer can be provided for each connecting section.

To form a membrane tube, it is thus possible for a plurality of membrane tube elements to be arranged in series and joined, with two adjacent connecting parts joined to one another forming a connecting section. Adjacent connecting parts are preferably joined to one another adhesively (German: stoffschlüssig) (for example by means of a welded, soldered or positive-substance-join) and/or by positive-locking (German: formschlüssig) (for example by means of a screw connection). In a preferred variant, connecting parts to be joined have a mutually compatible thread at the periphery, so that they can be screwed together by twisting. In particular, the connecting part of a membrane tube element can have an internal thread at the periphery, while the connecting part to be joined thereto of the adjoining membrane tube element has a corresponding external thread at the periphery. In the interests of gastightness, the connecting parts which have been screwed together can subsequently be welded together by means of a circumferential welded seam at the places where the two connecting parts abut.

For the purposes of the present invention, a membrane is a thin layer of a material which is selectively permeable to particular types of gas (in particular H₂). The membrane (or the material thereof) is selected according to the gas to be separated off (e.g. H₂). The further gases present in the respective gas mixture may also have to be taken into account in the design and materials selection of the components of the membrane tube or membrane tube element, especially when a component is to be made gastight for all of these gases of the gas mixture.

For the isolation of hydrogen, pure metals which have a certain permeability for hydrogen but represent a barrier to other atoms/molecules are in principle well suited as materials for the membrane. With a view to avoiding the formation of an oxide layer which would impair this selective permeability, preference is given to using noble metals, in particular palladium, palladium-containing alloys (in particular containing more than 50% by weight of palladium), e.g. palladium-vanadium, palladium-gold, palladium-silver, palladium-copper, palladium-ruthenium, or else palladium-containing composite membranes, for example with the layer sequence palladium, vanadium, palladium, for separating off hydrogen (H₂). In one embodiment, the membrane is accordingly made of palladium or a palladium-based, metallic material (e.g. alloy, composite, etc.). The Pd content of such membranes is, in particular, at least 50% by weight, preferably at least 80% by weight.

The membrane can generally be configured as free-standing sheets or as (at least) one layer on a support substrate. The support substrate has a tubular basic shape and performs a mechanical support function. Its cross section is preferably circular with a constant diameter along the axial direction. As an alternative, however, it is also possible to provide another closed cross section, for example an oval cross section, and a cross section which widens along the axial direction. The support substrate is porous and gas-permeable in order to allow, depending on the gas flow direction, the supply of gas to or transport of gas away from the membrane. A metallic material is preferably used for the support substrate; a metallic support substrate is, compared to ceramic support substrates, cheaper to produce, easier to seal in the transition region to the connecting section or connecting part and relatively easy to join to the connecting section or connecting part, for example by means of a welding process, in particular with a material-to-material bond. The production of such porous, gas-permeable, metallic support substrates is carried out, in particular, by means of a powder-metallurgical production process which comprises the steps of shaping (e.g. pressing) and sintering of metallic starting powders, giving porous support substrates having a microstructure typical of powder-metallurgical production. Suitable materials for the support substrate are, in particular, iron (Fe)-based, i.e. containing at least 50% by weight, in particular at least 70% by weight, of Fe) alloys having a high chromium content (chromium: Cr) (e.g. at least 16% by weight of Cr), to which further additives such as yttrium oxide ((Y₂O₃) (to increase the oxidation resistance), titanium (Ti) and molybdenum (Mo) can be added, with the proportion of these additives in total preferably being less than 3% by weight (cf., for example, the ITM material from Plansee SE containing 71.2% by weight of Fe, 26% by weight of Cr and a total of less than 3% by weight of Ti, Y₂O₃ and Mo). Furthermore, interdiffusion effects between the metallic support substrate and the (generally likewise metallic for the isolation of H₂) membrane occur at the high operating temperatures (typically operating temperatures in the gas separation in the range 450-900° C.), and these would lead over time to degradation or destruction of the membrane. To avoid these disadvantages, at least one ceramic, gas-permeable, porous intermediate layer (e.g. of 8YSZ, i.e. of zirconium oxide fully stabilized with 8 mol % of yttrium oxide (Y₂O₃)) can be provided between the support substrate and the membrane. It suppresses interdiffusion effects between the support substrate and the membrane. Furthermore, the pore size can be reduced over it, optionally stepwise (in particular by application of a plurality of intermediate layers, i.e. by means of a “gradated layer structure”) and a smooth surface for application of the membrane can be made available.

The membrane extends over the entire cylindrical outer surface of the porous support substrate. Sealing (apart from the permeability for the gas to be separated off) is effected in the region of the support substrate by the membrane. For completely gastight joining to appropriate connecting conduits of the plant (e.g. reactor) or for joining to further membrane tube elements, a connecting section consisting of a material which is gastight at least on the surface or a connecting part is provided directly adjoining the support substrate. The gastight region of the connection section or connecting part is on the outside, i.e. it is thus located on the same side as the membrane on the adjoining support substrate. The connecting part or connecting section is preferably an all-metallic component. The basic shape is likewise tubular. The connecting section or the connecting part can perform further functions, e.g. combining or dividing a plurality of connecting conduits. For this purpose, appropriately functionalized sections can be molded onto the connecting section or the connecting part and/or be joined to this.

The connecting section or the connecting part is preferably adhesively (e.g. by means of a welded join or a solder join) joined to the tubular support substrate at least at an end face, with the positive-substance-join extending, in particular, around the entire circumference of the adjoining components. A welded join is inexpensive and can be produced reliably. The positive-substance-join can also be produced by an integral configuration of the connecting section (or connecting part) and the support substrate has one component.

To seal the transition region between the connecting part or connecting section and the support substrate, the membrane itself or a layer which is gastight for all gases of the gas mixture or for the further gases present in addition to the gas to be separated off can be, in particular, extended in the axial direction slightly beyond the porous support substrate to over the connecting part or the connecting section in order then to end on the connection section or connecting part.

The key idea of the invention is that at least one spacer which projects in the radial direction to above the membrane is provided in the region of the connecting section or connecting part. This has great advantages when a plurality of membrane tubes is assembled into a bundle in a membrane tube system. In such a membrane tube system, a plurality of membrane tubes are arranged parallel to one another, with connecting sections or spacers of adjacent membrane tubes corresponding to one another, i.e. being arranged at the same height. This ensures that a spacer can come into mechanical contact only with a spacer of an adjacent membrane tube or with a corresponding connecting section of an adjacent membrane tube (e.g. when a spacer is provided in the region of the connecting sections only on each second membrane tube) and touching, frictional contact, etc., between spacer and membrane are avoided. The projecting spacer is positioned and dimensioned in such a way that in the case of stresses as can normally occur during transport, on start-up (heating up of the plant with associated longitudinal expansion of the membrane tubes) or during operation (due to vibrations caused by gas flows), any mechanical contact between adjacent membrane tubes occurs exclusively via spacers. Membrane tube sections of adjacent membrane tubes are therefore prevented from touching one another and the risk of damage to the membrane around the outside of the membrane tube sections is significantly reduced.

In a preferred embodiment, the spacers of directly adjacent membrane tubes are arranged at the same height. In the case of contact, the spacer in this case strikes the spacer of the adjacent membrane tube and not the connecting section of the adjacent membrane tube.

Adjacent membrane tubes can, in the installed state, be arranged very close to one another and be in mechanical contact (via the spacers) but can also be arranged without contact at a distance from one another, as a result of which a gap remains between spacer and neighboring membrane tube section or spacer of the neighboring membrane tube. The latter arrangement can assist the flow of the process gases in the outer region.

In the first-mentioned arrangement, the membrane tubes are preferably not adjoined rigidly via the spacers to the adjacent membrane tubes, i.e. adjacent membrane tubes do not have a material-to-material, physical locking or adhesive bond, for example a welded join, to adjacent membrane tubes in the region of the connecting sections. As a result, relative, axial movements between adjacent membrane tubes are to a certain extent possible, so that stresses, for example due to different thermal expansion, are comparable and do not lead to distortion.

In a preferred embodiment, the bundle of membrane tubes is mechanically fixed at least at a periphery, with there being connection possibilities for introduction and/or discharge of the process gases. The membrane tubes can also be mechanically fixed at the outer end and have further connection possibilities for introduction and/or discharge of the process gases. However, it is also possible for the membrane tubes to be free at the other end and, for example, to be closed off in a gastight manner by means of a connecting part having an end cap. It has been found to be advantageous for this connecting part with end cap also to be provided with a spacer in order to avoid contact of the membranes at their ends.

The individual membrane tubes are preferably arranged within an enclosing outer tube which forms a boundary of the outer process gas space. In this case, the spacers of the outer membrane tubes also serve as spacers from the enclosing outer tube.

In an advantageous embodiment, the spacer projects radially above the connecting section around the circumference, and the spacer particularly preferably has an annular shape. This results in a distance-maintaining function in every radial direction (360°).

The spacer is preferably made of a material which is resistant to a temperature as high as 900° C. It is advantageous for the spacer to be made of a metallic material and consist of the same material as the connecting section or the connecting part. As a result, the thermal expansion properties are identical and the risk of thermally induced stresses on start-up is reduced.

In a preferred embodiment, the spacer is adjoined by material-to-material bonding and/or positive-locking to the connecting section and thus guarantees a reliable connection to the connecting section even at high temperatures and/or high pressure differences. The material-to-material bonding can, for example, be realized by a solder join, positive-substance-join and/or welded join, and the positive-locking connection can, for example, be realized by means of a screw connection. A material-to-material bond can also be realized by integral construction of the connecting section (or connecting part) and the spacer as one component.

Various design variants of the spacer are conceivable. A plurality of membrane tube elements are frequently connected in series in a gastight manner to form a membrane tube. With a view to inexpensive production, the configuration of the spacer can be concomitantly taken into account or combined with the configuration of the join between the two connecting parts.

In an advantageous embodiment, the spacer is molded by buildup welding in the connecting section or connecting part. Here, for example, the circumferential welded seam by means of which the two connecting parts are joined can be thickened to form a spacer. In this case, only one process step is thus necessary in order to realize the join between the membrane tube elements and also the spacer.

In a further embodiment, the spacer can be formed by means of a spacing disk which is joined by positive-locking (German: formschlüssig) and/or by material-to-material bonding to the connecting section. The spacing disk is preferably welded in between the two connecting parts.

In a further variant, the connecting section can have a collar. For this purpose, one connecting part of the two adjoining connecting parts of the connecting section can, for example, be configured as tube section with a collar.

The spacer can also be realized by means of an intermediate piece which is arranged between the two connecting parts. The intermediate piece can, for example, be configured as a sheath with (central) collar which is welded in between the membrane tube elements adjoining the two connecting parts. Due to this intermediate piece, no collar or other spacer is necessary on the individual membrane tube elements, which makes automation of the manufacture of the membrane tube elements easier.

The membrane tube preferably has a length of at least 0.5 m, in particular at least 0.8 m. The membrane tube preferably has a diameter d in the region of the membrane tube sections such that 0.3 cm≤d≤1.2 cm, in particular 0.5 cm≤d≤0.8 cm.

Further advantages and useful aspects of the invention can be derived from the following description of working examples with reference to the accompanying figures.

The figures show:

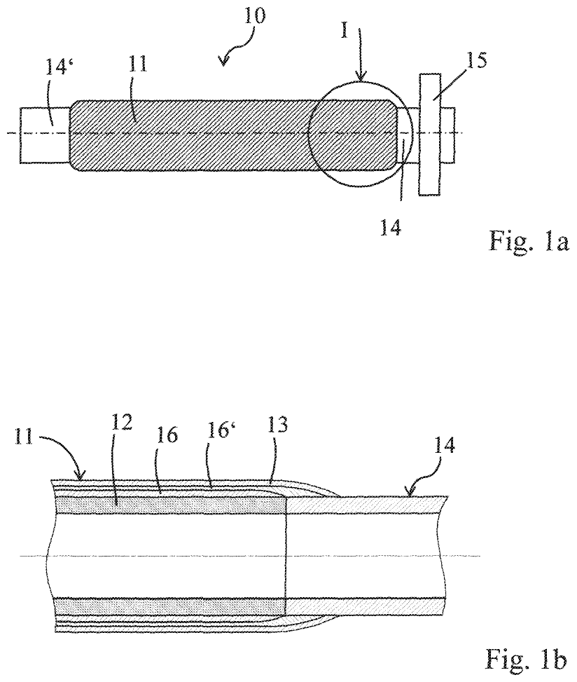

FIG. 1a: a schematic view of a membrane tube element according to the invention;

FIG. 1b: an enlarged section of the region denoted by I in FIG. 1 in the transition region between membrane tube section and connecting part in a schematic cross-sectional view;

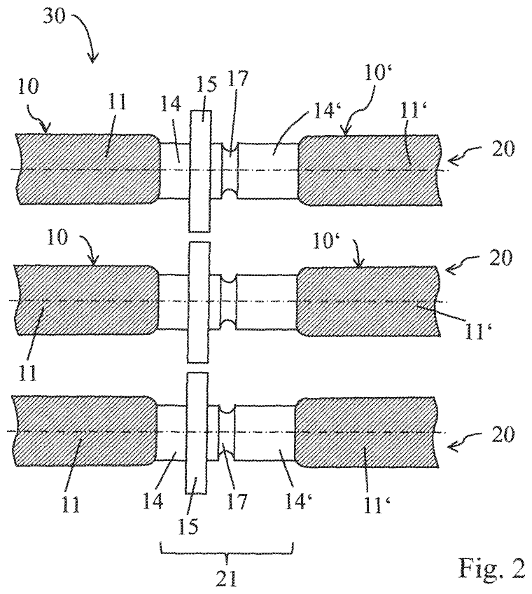

FIG. 2: a schematic view of a membrane tube system according to a first embodiment of the invention;

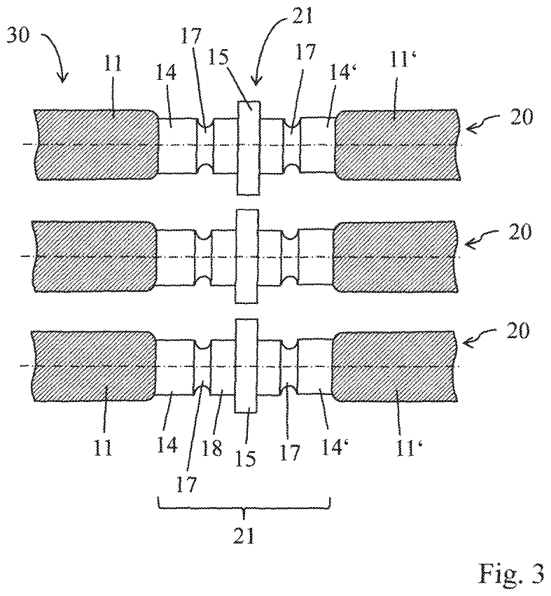

FIG. 3: a schematic view of a membrane tube system according to a second embodiment of the invention;

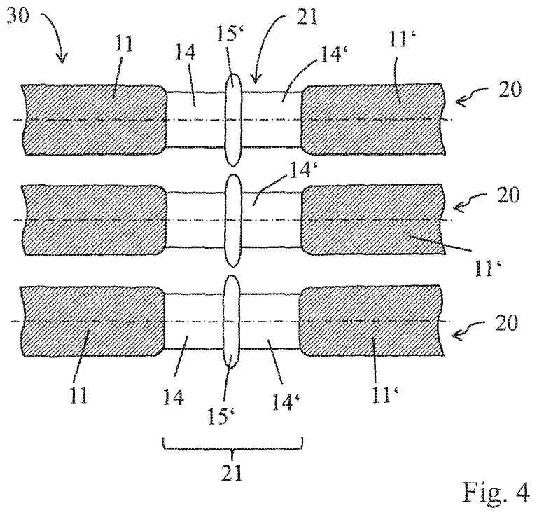

FIG. 4: a schematic view of a membrane tube system according to a third embodiment of the invention;

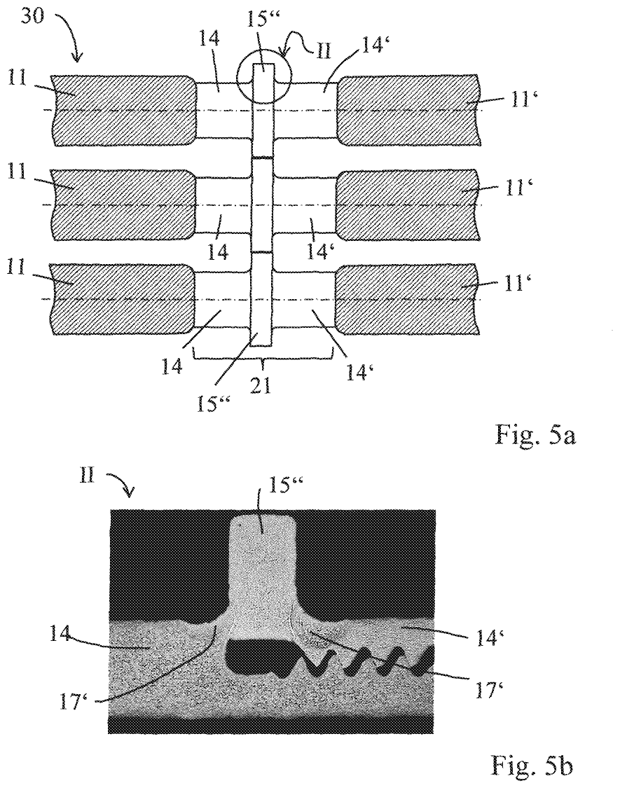

FIG. 5a: a schematic view of a membrane tube system according to a fourth embodiment of the invention;

FIG. 5b: an enlarged section of the region denoted by II in FIG. 5a around the spacer in a cross-sectional view.

FIG. 1a depicts an example of a membrane tube element for the permeative separation of a gas to be separated off (e.g. H₂) from a gas mixture (e.g. steam-reformed natural gas, containing CH₄, H₂O, CO₂, CO, H₂, etc.), with the region denoted by I in FIG. 1a in the transition region between membrane tube section and connecting part being shown enlarged in FIG. 1b. The membrane tube element 10 has a tubular membrane tube section 11 and a tubular connecting part 14, 14′ at each of the end faces. The two connecting parts 14, 14′ serve for gastight connection to supply or discharge tubes of the gas separation plant or for joining to a further membrane tube element in order to form, as indicated in the subsequent FIG. 2, a membrane tube made up of a plurality of membrane tube elements connected in series. As shown in FIG. 1b, the membrane tube section 11 is made up of a tubular, porous, gas-permeable, metallic support substrate 12 (e.g. composed of ITM) along the (circular) end face of which the tubular connecting part 14′ made of solid metal (e.g. steel) is joined via an adhesive bond, for example a welded join. The support substrate 12 and the connecting parts 14, 14′ can also be configured as integral or monolithic component, e.g. composed of a porous, gas-permeable base material, with the outside surface of the connecting parts subsequently having to be made gastight. Gastightness on the surface can, for example, be achieved by application of a coating or a sealing composition or by melting of the surface of the porous base material of the connecting part 14, 14′.

A membrane 13 (e.g. made of Pd) which is selectively permeable to the gas to be separated off and, (apart from the permeability for the gas to be separated off) forms a seal in the region of the support substrate; extends over the entire cylindrical outer surface of the porous support substrate. To suppress interdiffusion effects which occur between the metallic support substrate 12 and the membrane 13 (which is normally likewise metallic in the case of H₂ being separated off) at high operating temperatures, two ceramic, gas-permeable, porous intermediate layers 16, 16′ (e.g. made of sintered 8YSZ) are arranged between the support substrate 12 and the membrane 13 and extend over the entire gas-permeable surface of the support substrate. This second intermediate layer 16′ extends slightly beyond the first intermediate layer 16 and ends directly on the connecting part 14. The first intermediate layer 16 has a smaller average pore size than the support substrate 12, and the second intermediate layer 16′ has an even smaller average pore size compared to the first intermediate layer 16. The second intermediate layer 16′ serves to provide a sufficiently smooth substrate for the subsequent membrane 13. This subsequent membrane 13 extends beyond the two intermediate layers 16 and 16′ and ends directly on the connecting part 14, which ensures reliable sealing even in the transition region between support substrate 12 and connecting part 14. The sealing between support substrate 12 and connecting part 14′ is effected analogously.

In the case of the present membrane tube element 10, a spacer 15 in the form of a collar is provided on a connecting part 14. In the present example, the connecting part 14 has been produced from a thick-walled tube from which a tube section having the collar 15 was turned.

Further embodiments of the spacer can be seen in FIG. 2 to FIG. 5. In these figures, sections of a membrane tube system (module) 30 having three membrane tubes 20 are shown in each case. The figures depict only a section, both in respect of the number of membrane tubes in a module (a plurality of membrane tubes, typically up to several hundred membrane tubes, are usually installed parallel to one another as a bundle within an outer tube in a module) and in respect of an individual membrane tube (only that part of a membrane tube where two membrane tube elements abut is depicted). An individual membrane tube consists of a plurality of membrane tube elements which are arranged in series and are connected by a material bond (German: stoffschlüssig) at the end faces to the connecting parts. In the embodiments depicted, they are welded together at the end faces by means of a laser; the welded seam is denoted by 17 in the figures. The membrane tubes are mechanically fixed (not shown) at least on one side and can there be connected to connection conduits of the plant (not shown). To delimit the outer process gas space, the individual membrane tubes are usually arranged within an enclosing outer tube (not shown).

FIGS. 2 to 5 each depict three membrane tube sections which are formed by the juxtaposition of membrane tube elements 10, 10′. The two connecting parts 14, 14′ of adjacent membrane tube elements 10, 10′ form the connecting sections 21. A spacer 15; 15′, 15″ which projects in the radial direction above the membrane is provided for each connecting section. The connecting sections 21 of adjacent membrane tubes correspond to one another, i.e. are arranged at the same height; in the working examples shown, the spacers are also arranged at the same height. The spacers are dimensioned so that in the case of stresses as normally occur during transport, on start-up or during operation, any mechanical contact between adjacent membrane tubes occurs exclusively via spacers and the membranes of adjacent membrane tubes cannot touch one another. The spacers 15; 15′; 15″ also act as spacers from the enclosing outer tube.

In the case of the membrane tubes 20 in FIG. 2 to FIG. 4, the membrane tubes are arranged close together but at a distance from one another with a small gap between the spacers of adjacent membrane tubes in the installed state. This assists the flow of the process gases in the outer region. In the variant depicted in FIG. 5, the spacers are already in mechanical contact in the normal positioning, as a result of which a more compact construction of the module is made possible. The spacers of adjacent membrane tubes are, however, not joined to one another but allow, in particular, axial movements in order to be able to compensate for mechanical stresses caused, for example, by different thermal expansion, as can occur, for example, during start-up of the plant.

FIG. 2 shows a membrane tube system based on membrane tube elements from the working example in FIG. 1. The connecting section 21 consists of a tubular connecting part 14′ which is welded at a connecting part 14 to a collar of the adjoining membrane tube element 10. The spacer can, as in the working example of FIG. 3, be realized by means of an intermediate piece 18 which is welded in between the two connecting parts 14, 14′. The intermediate piece is made of a thick-walled tube section from which a sheath having a central collar has been turned. This working example has advantages in the manufacture of the individual membrane tube elements since these then do not have a collar and are therefore easier to manufacture.

In the working example of FIG. 4, the spacer 15′ can be configured as an annular welded seam by the circumferential welded seam by means of which the two connecting parts are joined being made thicker. In this variant, only one welding operation is necessary in order to both join the membrane tube elements and also realize the spacer.

FIG. 5a shows, in a side view, an embodiment in which the spacer 15″ is realized by means of a spacing disk. As shown in the enlarged depiction in FIG. 5b, a connecting part 14′ has an outer thread on its periphery into which the other connecting part 14 has been screwed by means of a corresponding peripheral internal thread and a spacing disk 15 threaded in between. The spacing disk is welded on both sides to the connecting parts at the circumferential welded seams 17.

The production of the membrane tube elements as is used for the above-described membrane tube system but also for the other working examples will be discussed briefly below. A support substrate in the form of a porous tube made of ITM and having an external diameter of 10 mm, a length of 100 mm, a porosity of about 40% and an average pore size of <50 μm is welded at both end faces to a tubular connecting part made of solid steel and having the same external diameter by laser welding. To homogenize the welded transitions, the component obtained is heat treated at a temperature of 1200° C. under a hydrogen atmosphere. After smoothing of the surface by means of sandblasting, an 8YSZ powder having a d80 of about 2 μm is, to produce the first intermediate layer, prepared in a suspension suitable for a wet-chemical coating process, for example with addition of dispersant, solvent (e.g. BCA [2-(2-butoxyethoxy)ethyl] acetate, obtainable from Merck KGaA Darmstadt) and binder. The connecting parts are subsequently covered up to the welded seam and the first intermediate layer is applied by dipcoating to the beginning of the welded seam. After drying, the covering is removed from the gastight surface of the connecting parts and the component obtained is subsequently sintered at a temperature of 1300° C. under a hydrogen atmosphere, as a result of which the organic constituents are burnt out, sintering of the ceramic layer takes place and the porous, sintered ceramic first intermediate layer 16′ is obtained. The production of the second intermediate layer 16″ is carried out analogously, with a finer 8YSZ powder being used and a somewhat lower viscosity of the suspension than in the case of the first intermediate layer being set. The second intermediate layer is likewise applied by dip coating. The second intermediate layer completely covers the first intermediate layer and ends directly on the connecting parts. The component obtained is sintered at a temperature of 1200° C. under a hydrogen atmosphere, as a result of which the organic constituents are burnt out, sintering of the ceramic layer takes place and the porous, sintered, ceramic second intermediate layer is obtained. A Pd membrane is subsequently applied by means of a sputtering process. It completely covers the second intermediate layer and also the first intermediate layer underneath. Finally, a further Pd coating is applied on top of the sputtered Pd layer by means of an electrochemical process in order to seal the sputtered layer and achieve the required gastightness.

The present invention is not restricted to the embodiments depicted in the figures. The structure described is suitable not only for separating off H₂ but also for separating off other gases (e.g. CO₂, O₂, etc.). Furthermore, it is possible to use alternative membranes such as microporous, ceramic membranes (Al₂O₃, ZrO₂, SiO₂, TiO₂, zeolites, etc.) or dense, proton-conducting ceramics (SrCeO_{3-δ}, BaCeO_{3-δ}, etc.). Furthermore, a spacer can be provided within a membrane tube system at the height of neighboring connecting sections of a plurality of membrane tubes only at each second connecting section, so that the spacers in each case ensure the distance to the neighboring connecting section (and not to a neighboring spacer). Based on the axial direction of a membrane tube, it is also possible, for example, a spacer to be provided only at each second or third connecting section.

1-15. (canceled)

16. A membrane tube element for a permeative separation of a gas from a gas mixture, the membrane tube element comprising:
a membrane tube section having a porous, gas-permeable, metallic, tubular support substrate, said tubular support substrate having an end face;
a membrane that is selective for the gas to be separated off applied around a circumference of said membrane tube substrate;
at least two connecting parts that are gastight at least on a surface thereof;
said tubular support substrate being joined at each end face thereof to a respective connecting part; and
at least one spacer disposed at one of said connecting parts, said at least one spacer projecting in a radial direction to above said membrane.

17. A membrane tube for a permeative separation of a gas from a gas mixture, the membrane tube comprising:
at least two membrane tube sections each having a porous, gas-permeable, metallic, tubular support substrate and a membrane that is selectively permeable for the gas to be separated off and that is applied around a circumference of said support substrate;
at least one connecting section that is gastight at least on a surface and configured to join two adjacent said membrane tube sections to one another; and
at least one spacer disposed in a region of said at least one connecting section and projecting in a radial direction to above said membrane.

18. The membrane tube according to claim 17, wherein said spacer projects radially circumferentially above said connecting section.

19. The membrane tube according to claim 17, wherein said spacer is annular.

20. The membrane tube according to claim 17, wherein said spacer is connected to wais connecting section by a material bond and/or by a positive-locking connection.

21. The membrane tube according to claim 17, wherein said connecting section is joined to said support substrate by a material bond.

22. The membrane tube according to claim 17, wherein said spacer is made of a metallic material.

23. The membrane tube according to claim 17, wherein precisely one spacer is provided per connecting section.

24. The membrane tube according to claim 17, wherein said connecting section is formed of two connecting parts which are each joined to a respective said membrane tube section.

25. The membrane tube according to claim 17, which comprises an intermediate piece having said spacer installed thereon and arranged between said two connecting parts.

26. The membrane tube according to claim 17, wherein said spacer is an element having been formed by buildup welding.

27. The membrane tube according to claim 17, which comprises an end cap disposed to close off said membrane tube, said end cap being gastight at least on a surface thereof and being joined to said support substrate or connecting section.

28. The membrane tube according to claim 16, which comprises an end cap disposed to close off said membrane tube, said end cap being gastight at least on a surface thereof and being joined to said support substrate or connecting section.

29. A membrane tube system, comprising:
at least two membrane tubes according to claim 17 disposed parallel to one another;
wherein said spacers are each arranged at a height of said connecting section of adjacent membrane tubes.

30. The membrane tube system according to claim 28, wherein at least two spacers of directly adjoining membrane tubes are arranged at the same height.

31. The membrane tube system according to claim 28, wherein said membrane tubes are arranged within an outer tube.
